(19) United States
(12) Patent Application Publication
(10) Pub. No.: US 2004/0223056 A1
(43) Pub. Date: Nov. 11, 2004

(54) Perimeter intrusion detection and deterrent system

(76) Inventor: Victor J. Norris JR., Parkville, MD (US)

Correspondence Address: John de la Rosa, 375 Upper Mountain Avenue, Montclair, NJ, 07043, US

(21) Appl. No.: 10/779,273

(22) Filed: Feb. 13, 2004

Related U.S. Application Data
(60) Provisional application No. 60/447,242, filed on Feb. 13, 2003.

(51) Int. Cl. H04N 7/18

(52) U.S. Cl. 348/152; 348/143

(57) ABSTRACT

A system for protecting strategic facilities against terrorists by providing perimeter intrusion detection and deterrence is realized by employing sensors operating in “solar blind” region of the ultraviolet spectrum. Such sensors are unique in that their performance is not background noise limited, as well as operable under low visibility conditions. In one preferred embodiment, the inventive “terrorist shield” system comprises two shields surrounding a strategic facility. A detection shield arranged along a circumference at a known radius from the center of the strategic facility serves as the primary means of detection. The detection shield employs UV sources and sensors housed in poles arranged equidistant along the outer circumference of the detection shield. The system also includes a deterrent shield, representing the countermeasures employed in thwarting the terrorist as he approaches or nears the lethal range of the facility. An assessment area between the two shields allows for covert threat assessment that is afforded by imaging systems. This assessment area uses interior covert UV beams that criss-cross to assist in tracking the movement of the terrorist. Depending upon the circumstances, the operator can take different countermeasures.

This application claims the benefits of U.S. Provisional Application No. 60/447,242 filed Feb. 13, 2003, entitled “Terrorist Shield,” which is incorporated herein by reference.

### TECHNICAL FIELD

This invention relates to security systems, and more particularly, to systems for protecting strategic facilities against terrorists by providing perimeter intrusion detection and deterrence.

### BACKGROUND OF THE INVENTION

A terrorist must be deterred before he gets within a lethal striking distance of a strategic target, or the so-called “lethal range.” To accomplish this, a target defender must be aware of the terrorist's intentions and movements early enough in the terrorist's progress to take control of the encounter. The defender, appropriately armed, can then take action consistent with the circumstances, so as to prevent the terrorist from inflicting damage.

In the prior art, systems employed to protect strategic facilities use sensors placed at adequate distances from strategic facilities to detect the terrorists before they reach the “lethal range.” Typically, large numbers of low cost sensors are positioned around the perimeter of the facility. These sensors report an intrusion over wireless links to a limited number of more expensive imaging sensors that can be remotely pointed to the segment of the perimeter that was trespassed. In this manner, real time images of the trespass scene can then be relayed over wireless links so that security personnel might assess the situation, and take immediate and appropriate action. Such a systematic and swift response is essential for the interception of a terrorist before he is within a lethal range.

In the prior art, the effectiveness of robust, tactical, perimeter intrusion detection systems has been, however, somewhat limited. These limitations are generally due to the sensors having short detection ranges and/or high false alarms. For example, typical sensors employed today by the U.S. Army have only a range of 25 meters, with efforts underway to extend these ranges to 50 meters. The most effective sensors—typically employing acoustic or seismic detection techniques—unfortunately, are prone to false alarms. This is particularly true when they are used over large circular areas as stand alone devices. The sheer number of these sensors also presents detection location issues as the sensors are polled over RF links.

The U.S. Air Force is also developing sensors that have intrusion detection ranges of up to 100 meters. These sensors are primarily infrared or millimeter wave devices. The infrared devices do not perform well under low visibility conditions, as well as suffer from high false alarms. The false alarms are due to the unintentional introduction of intense infrared beams, such as truck headlights and the like, that radiate at the same IR wavelength, into the field of view of the infrared sensor.

### SUMMARY OF THE INVENTION

A system for protecting strategic facilities against terrorists by providing perimeter intrusion detection and deterrence is realized by employing sensors operating in “solar blind” region of the ultraviolet spectrum. Such sensors are unique in that their performance is not background noise limited, as well as operable under low visibility conditions.

In one preferred embodiment, the inventive “terrorist shield” system comprises two shields surrounding a strategic facility. A detection shield is arranged along a circumference at a known radius from the center of the strategic facility, and an inner deterrent shield formed along a circumference varying about a nominal radius, known as the “lethal range.” The deterrent shield represents the countermeasures employed in thwarting a terrorist as he approaches or nears the lethal range. An assessment area between the two shields allows for covert threat assessment.

Covert assessment is afforded by imaging systems, including cameras, that are controlled by the operator at the command post. The command post contains the necessary communication links, controls and displays, to allow the operator to be aware and assess the situation over the area being monitored, and to take appropriate action to neutralize an invading terrorist. Information and commands are transferred to and from the command post via secure RF links.

The outer detection shield serves as the primary means of detection, whereas the assessment area serves to assist in monitoring the progression of a terrorist as he moves toward the strategic facility. UV sensors operating in the solar blind region are housed within security poles arranged equidistant along the outer circumference of the detection shield. The outer detection shield is formed by the interaction of two type of sensors that constitute an electromagnetic curtain along the circular boundary of the detection shield: a ported coaxial radio frequency (RF) sensor cable, and a vertically stacked series of covert ultraviolet (UV) beams radiating within the solar blind spectrum. The RF sensor cable is buried below ground, radiating an arc pattern above the terrain and on either side of the cable. The RF sensor cable detects the presence of most objects of reasonable size that pass within or through its pattern.

Radiation sources housed within each of the security poles generate ultraviolet radiation within the solar blind region so as to produce covert ultraviolet (UV) beams. In operation, the emitted radiation propagates through the atmosphere, and is directed to corresponding UV sensors located within an adjacent security pole. On a corresponding security pole are UV sensors for detecting the presence or absence of the beams, thereby indicating an intrusion. The placement of the covert UV beams within the upper portion of the RF sensor cable results in detection of anyone attempting to bridge the RF beam. Also, the covert UV beams serve as an independent means for intrusion detection, or as a confirming indication of an intrusion following an initial intrusion detection by the RF sensor cable.

The assessment area is defined and realized by additional inner UV beams that criss-cross. Additional UV sources form the inner UV beams. As a terrorist moves in the direction of the targeted facility, he interrupts the interior UV beam curtains formed between the corresponding security poles. These interior UV beam curtains are each comprised of a series of vertically stacked UV beams. Interruptions of these beam curtains provide an independent indication to the operator of the terrorist's movement within the assessment area. He may rely upon these progression indications if he has lost image track of the terrorist's movements.

The interruption of covert UV beams will be detected by the UV sensors, and then relayed to the command post. Following initial detection, the terrorist's movements are tracked via imaging systems, and interruptions of inner UV beams within the assessment area assist in monitoring the movement of the terrorist. Upon imaging of the terrorist and his “baggage”, the operator assesses the situation and elects a course of action. The terrorist may be crawling along the ground and dragging a pouch, running, or he may be one of a group that is moving in a vehicle. In the assessment process, the operator is also prepared for a diversionary tactic. Depending upon circumstances, however, the operator can take different countermeasures constituting the deterrent shield. Such countermeasures are invoked as the terrorist nears or is at the lethal range of the facility.

### BRIEF DESCRIPTION OF THE INVENTION

A more complete understanding of the invention may be obtained by reading the following description in conjunction with appended drawings in which like elements are labeled similarly, and in which:

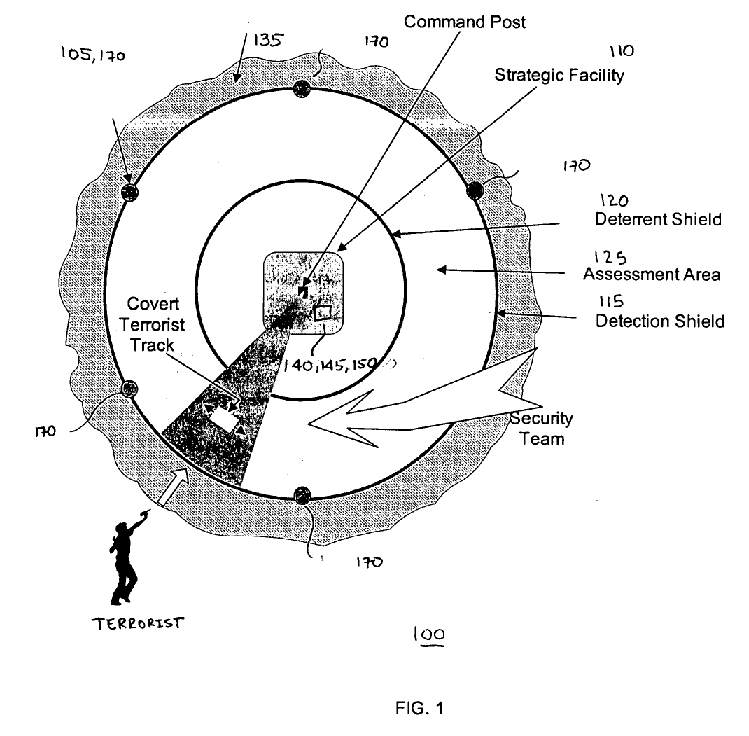

FIG. 1 is an overview depiction of the inventive terrorist shield system, particularly illustrating the interaction of the multiple detection means and multiple deterrence means;

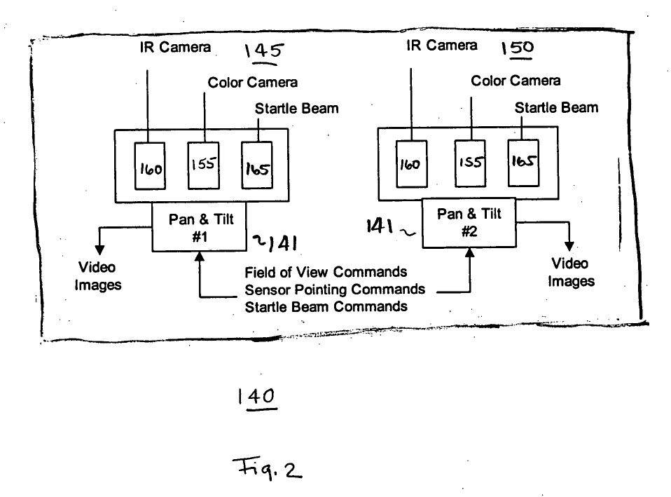

FIG. 2 is simplified block diagram of the imaging system depicted in block format in FIG. 1;

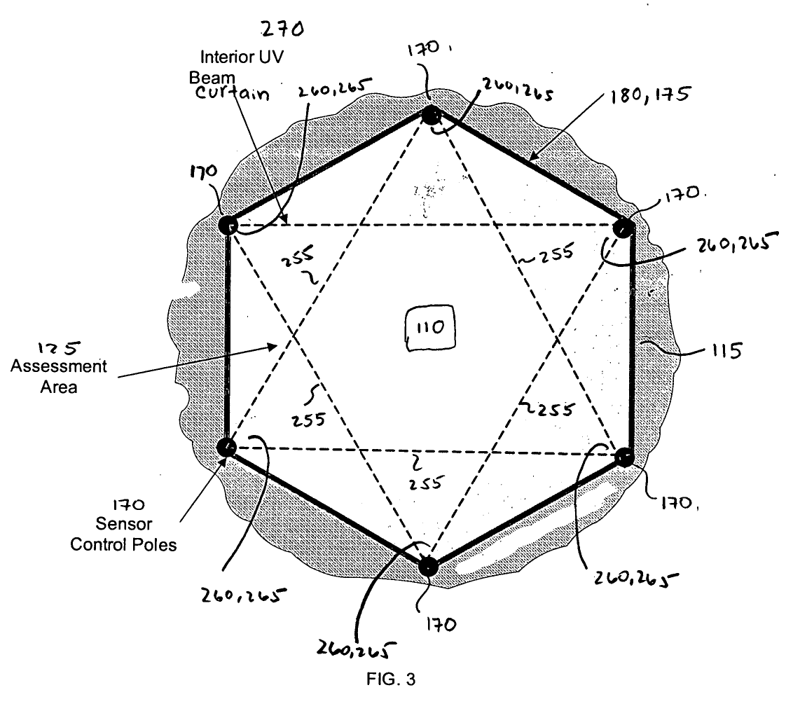

FIG. 3 is an pictorial illustration of the detection shield employed to monitor the encroachment of a terrorist;

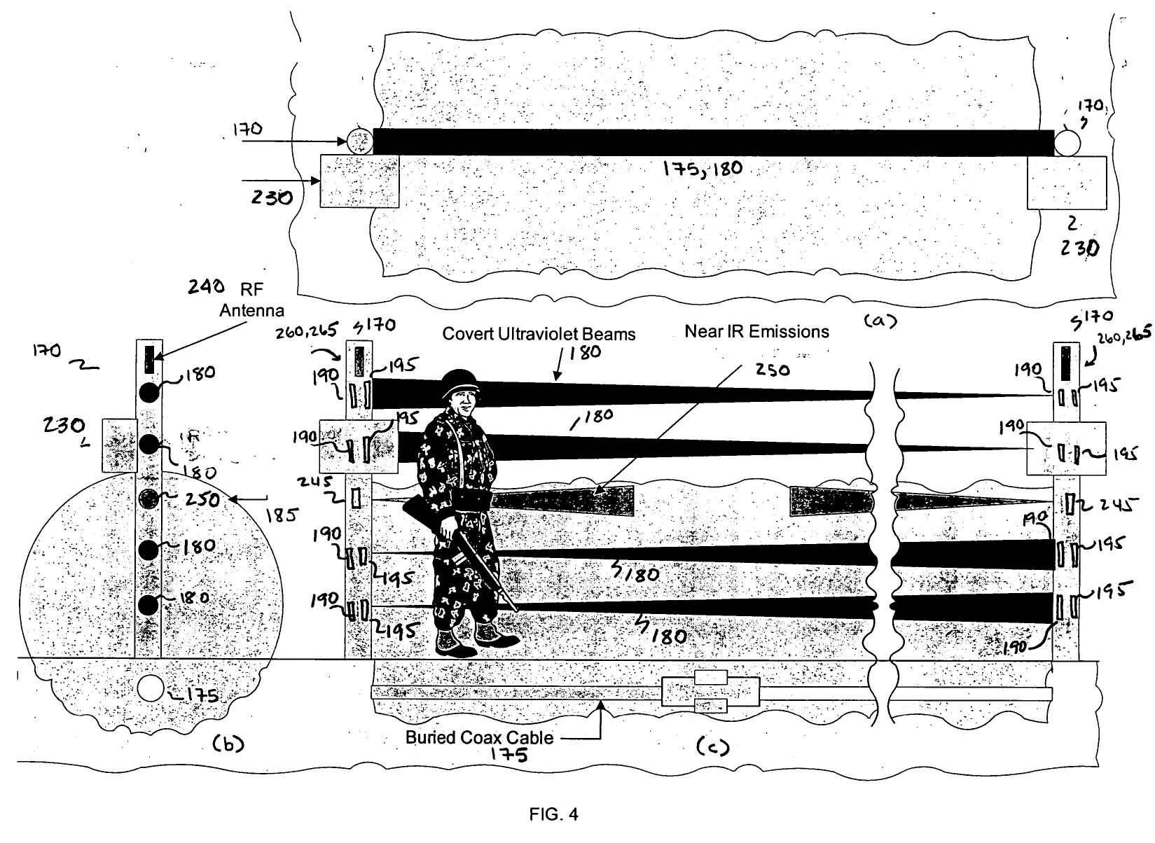

FIGS. 4(a)-(c) provides additional top, side and front illustrations, respectively, of the ultraviolet sources and sensors employed in the detection shield, as well as a complementary buried coax cable in accordance with principles of the present terrorist shield system;

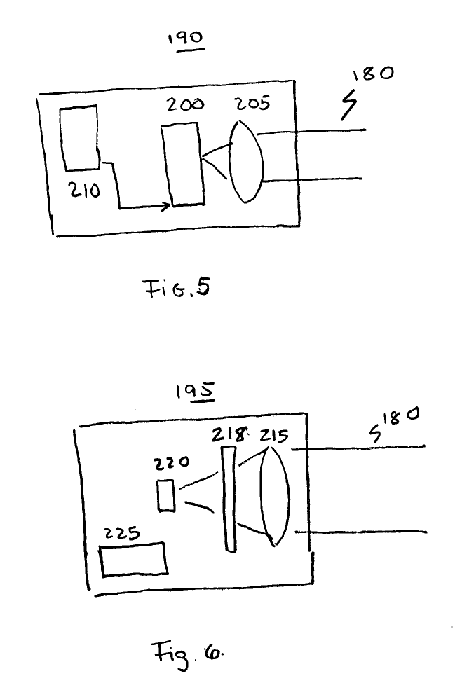

FIG. 5 is block diagram of the UV source employed in the detection shield of the present invention;

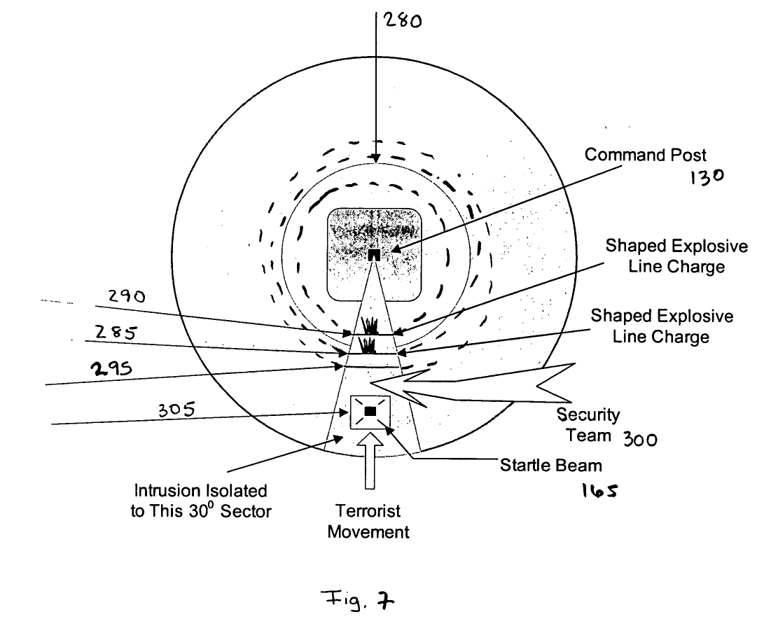

FIG. 6 is a block diagram of the UV sensor employed in the detection shield of the present invention; and

FIG. 7. is an illustration of the multiple deterrence that impedes the forward movement of the terrorist.

### DETAILED DESCRIPTION

A system for protecting strategic facilities against terrorists by providing perimeter intrusion detection and deterrence is realized by employing sensors operating in so-called “solar blind” region of the ultraviolet spectrum, not visible to the human eye. Also, in the “solar blind” region (˜0.205-0.275 μm), there is no natural radiation from the sun, and hence no background noise. Additionally, it has been discovered that radiation in this spectrum effectively propagates in a low visibility atmosphere, as more fully disclosed in U.S. Pat. No. 5,719,567, which is incorporated herein by reference. Such sensors are therefore unique in that their performance is not background noise limited, making them less susceptible to false alarms, as well as operable under low visibility conditions. Other sensors employing different and complementary technology further offer means to systematically minimize false alarms due to other circumstances, such as the movement of animals, and the like. Also, the choice of sensors, and their deployment architecture are judiciously chosen to provide a pro-active encounter with the terrorist.

The present invention provides distinct advantages over other currently available systems. With sensors operating in the solar blind region and having a range of 400 meters, fewer sensors are required to monitor a given perimeter, especially over large boundaries. The number of batteries to be serviced, and the number of radio frequency transceivers to be poled are reduced by factors of 4 to 16 by the use of solar blind sensors. These reductions are further multiplied when the number of supporting imaging sensors, radio frequency links, and controls and displays are considered.

The relatively small and innocuous appearance of the ultraviolet solar blind sensors offer additional opportunities in terms of deceiving and confusing the terrorists as they practice their modus operandi—assessing the vulnerability and destruction of strategic facilities. Detection is not an end unto itself for the protection of a site. Multiple layers of deterrence must be systematically brought to bear so that the terrorist's destruction mission is intercepted and neutralized before he reaches a lethal range. The present invention builds on the capability of the ultraviolet detection and the situation awareness and communication that has developed concurrent with detection to ensure timely terrorist interception by first responders.

Referring to FIG. 1, there is shown an overview depiction of the inventive “terrorist shield” system 100, employing a plurality of sensors operating in the so-called “solar blind” portion of the ultraviolet spectrum, which radiation is not visible to the human eye. The inventive system has an extremely low false alarm rate and is substantially immune to background variations. The use of non-visible radiation affords the use of covert means to assess a terrorist threat prior to initiating different counter-measures. With the terrorists viewed with covert sensors, the inventive terrorist shield system is applicable both to the initiation of a diversionary intrusion, and a later attack at a different approach sector to the facility.

Terrorist shield system 100 comprises two shields surrounding a strategic facility 110. A detection shield 115 is arranged along a circumference at a radius of, for example, one-quarter mile from the center of strategic facility 110; and an inner deterrent shield 120 along a circumference that varies about a nominal radius of, for example, 0.15 miles from strategic facility 110. Deterrent shield 120 is an illustrative representation of the countermeasures employed in thwarting the terrorist as they approach or are near the lethal range. The annulus between the two shields, known as assessment area 125, allows for covert threat assessment, as discussed herein below.

An operator in a command post 130 monitors terrorist activity following detection. Although it is preferable that command post 130 be on-site, it may be remotely located at another site where the operator is also performing other security functions. A sector 135 beyond detection shield 115 is, however, under random covert surveillance to discover methodical scrutiny by terrorists in the process of planning an attack.

A covert assessment of a terrorist's circumstances is afforded by imaging systems, including cameras, that are controlled by the operator at command post 130, located ideally at the center of detection shield 115 and deterrent shield 120. Command post 130 contains the necessary communication links, controls and displays, to allow the operator to be aware and assess the situation over the area being monitored, and to take appropriate action to neutralize an invading terrorist before he can disable strategic facility 110. Command post 130 can be manned by a single, dedicated operator, or his role can be transferred to a remote post. This remote command post has the same controls and displays as on-site command post 130, but the operator there can oversee the security, status, and maintenance of other sites, or attend to other unrelated security duties. Information and commands are transferred to and from command post 130 via secure RF links.

A platform 140 with a clear line of sight beyond the detection shield 115 is preferably located proximate to on-site command post 130. Two identical imaging systems 145, 150 are each mounted on individual pan and tilt drive assemblies 141 that are installed on the top of platform 140. Each imaging system is remotely steered over diametrically opposite sectors of 180 degrees each. Each imaging system consists of, for example, a visible color camera 155, an infrared (8.5-11 μm) camera 160, and a startle beam projector 165, as depicted in FIG. 2. The lines of sight of the cameras are bore-sighted to one another. The fields of view of the two imaging cameras are variable from about 1 to 4 degrees, with the scan width of the startle beam variable from about 0.1 to 1.0 degrees. The beam location can be seen within the field of view of the visible color camera, but unable to be detected by the infrared camera. The line of sight of each imaging system 145, 150 is individually joy stick-driven by the operator at either the on site post 130 or remote command post.

Outer detection shield 115 serves as the primary means of detection, whereas assessment area 125 serves to monitor the progression of a terrorist as he moves toward strategic facility 110. UV sensors operating in the solar blind region, and the controls that provide the detection are housed on or within six security poles 170 arranged equidistant along the outer circumference of detection shield 115, as depicted more clearly in FIG. 3.

Now referring also to FIG. 4, outer detection shield 115 is formed by the interaction of preferably two type of sensors that constitute an electromagnetic curtain along the circular boundary of detection shield 115: a ported coaxial radio frequency (RF) sensor cable 175, and a vertically stacked series of covert ultraviolet (UV) beams 180 radiating within the solar blind spectrum. A vertical stack of only four beams is, however, shown for illustration purposes in FIG. 4.

RF sensor cable 175 is buried about 12 inches below ground. It radiates in an arc pattern 185 that extends about 3.5 feet above the terrain and about ±1.8 feet on either side of the cable. The cable detection pattern is solid, unlike bistatic microwave transmitter and receiver elements that transmit detection patterns through air, which patterns have holes within 25 feet of either element. RF sensor cable 175 detects the presence of most objects of reasonable size that pass within or through its pattern. However, the static presence of metallic objects proximate to the cable can present detection anomalies. Also, slow passage across the pattern may be difficult to detect, as well as may be jammed. However, the pattern does follows the terrain. Therefore, attempts to tunnel under it or to crawl through it will be detected. Maximum cable lengths are about 650 feet, although detection cannot be localized within this length. The maximum perimeter coverage can be realized by extending two (2) 650-foot lengths in opposite directions from the a cable sensor module attached to a corresponding sensor pole 170.

Radiation sources 190 housed on or within each of security poles 170 generate ultraviolet radiation within the solar blind region so as to produce covert ultraviolet (UV) beams 180. In operation, the emitted radiation propagates through the atmosphere, and is directed to corresponding UV sensors 195 located on or within an adjacent security pole. Each radiation source 190 preferably includes an ultraviolet lamp 200, beam forming optics 205 and a modulator 210, as depicted in FIG. 5. Optics 210 is used to direct the ultraviolet radiation to sensors 195, and within a desired solid angle of illumination. Modulator 210 can modulate the radiation from lamp 200 to form a repetitive, characteristic radiation used in identifying the location of the beam when an intrusion is detected. Lamp 200 may be constructed from a variety of light sources, such as xenon, and mercury flashlamps which emit radiation in the desired ultraviolet spectrum. Alternatively, solid state UV lasers may be used.

As noted, on a corresponding security pole 170 that receives covert UV beams 180 are UV sensors 195 for detecting the presence or absence of beams 180, thereby indicating an intrusion. Sensors 195 each preferably comprises a lens 215, an optical filter 218, an ultraviolet detector 220 sensitive to radiation within the solar blind region, and control electronics 225, as depicted in FIG. 6. Optical filter 218 is a band-pass filter that passes radiation at wavelengths approximately between 0.205-0.275 μm. Substantial roll-off is used to attenuate solar radiation at wavelengths about 0.275 um. Preferably, optical filter 215 attenuates about an order of magnitude per nanometer between 0.275-0.290 μm. It is contemplated that optical filter 215 may comprise an absorption band-pass filter and/or comprise reflective filters in cascade.

The detection range of UV sensors 195 can extend to distances over two times that of RF sensors. UV sensor sensors 195 detect the presence of any object in the corresponding path of covert UV beams 180, and are substantially immune to background variations, except extremely dense fog. Placement of covert UV beams 180 within the upper portion of RF cable 175, and at heights above RF pattern 185 will result in detection of anyone attempting to bridge the RF beam. Covert UV beams 180 also serve as an independent means for intrusion detection, or as a confirming indication of an intrusion following an initial intrusion detection by RF cable 175. Interpretation of the response of the RF pattern with the individual responses of the covert UV beams 180, appropriately spaced, will thus ensure a high probability of detection, and a low occurrence of false alarms. The two sensors thus ideally complement one another. RF transmitters 230 on sensor poles 170 can transmit the signal from sensors 195 as well as from RF coax cable 175 to an RF receiver 235 located at command post 130 via RF antenna 240.

Alternatively, seismic or acoustic sensors may be employed instead of RF sensor cable 175 in circumstances where installation of a cable 12 inches below ground is not feasible. Each of these sensors has a range of about 75 to 100 feet. Seven to nine of these sensors could therefore be placed on the ground, or buried in shallow ground along the section defined by covert UV beams 180. Each of these sensors could be battery powered, including its radio frequency (RF) transceiver. Low power RF transmitters are activated when an acoustic or seismic sensor detects a deviation from the ambient patterns. Each of the transmitters has a unique ID code. When activated, it squawks its code to neighboring transceivers. These transceivers in turn relay the message, in daisy chain form, to the nearest sensor pole. Again, RF transmitters 230 can receives this signal and relays it to RF receiver 235. These seismic or acoustic sensors are inexpensive. The transducers and the processors are simple, since their sole role is to detect vibrations associated with digging or crawling, along a boundary formed by covert UV beams 180. The RF transceiver is likewise simple in that it merely serves as an annunicator or repeater along 200 ft line of sight distances. Typical battery life is on the order of 2-3 months. The inherent low cost of the sensors thus allows for abandonment and aerial replacement every two months, or replacement over the same time period. The seismic or acoustic sensors thus offer an alternative to RF buried cable 175 as well as an effective complement to the detection capabilities of covert UV beams 180.

A terrorist approaching detection shield 115 may not be aware of any physical characteristics that may be indicative of any intrusion shield. Sensor poles 170 around the circumference of detection shield 115 are typically separated by one quarter of a mile, and may not be visible. RF and electro-optical radiation from sources 175, 190 located near or on the poles are typically not visible. If a terrorist approaches the vicinity of a pole, he will see a six-foot high, five-inch diameter pole that has visibly opaque glass discs, housing the UV sensors and sources, embedded at various azimuthal angles and heights about the pole. If he suspects a detection device is present, it may not be clear what he can do to defeat it, or where he should do it.

To feed the above frustration, terrorist shield system 100 employs an IR transmitters 245 installed on each security pole 170 which produces IR beams 250 at two or more points along the height of the pole (only one shown in FIG. 4). None of these IR transmitters has a companion IR receiver. The transmitter wavelength is within the spectral response of night vision goggles (NVGs), and outside the visible response of the human eye. The transmitter's function is to provide an indication to a NVG equipped terrorist that an intrusion detection line has been formed with IR beams, and an interruption of this beam by him will signal an alarm. The terrorist therefore reasons that if he crawls under, goes between, or goes over individual beams, without blocking any of them, he can proceed to the facility, on foot, undetected. In the process of pursuing this course of action, he ensures that he will be detected by the RF and/or UV beams.

Now referring back to FIG. 3, assessment area 125 employs additional UV beams 255 that criss-cross. It should be noted that assessment area 125 is inside and contiguous with outer detection shield 115. Additional UV sources 260 that form UV beams 255, as well as corresponding sensors 265 are likewise located on security poles 170. UV sources 260 as well as sensors 265 are similar in construction to sources 190 and sensors 195, respectively. As the terrorist moves in the direction of targeted facility 110, after passing the primary detection shield 115, he interrupts interior UV beams curtains 270 formed between the corresponding security poles. These interior UV curtains 270 are each comprised of a series of vertically stacked UV beams 255 similar to covert UV beams 180. Interruptions of these beam curtains provide an independent indication to the operator of the terrorist's progression within assessment area 125. He may rely upon these progression indications if he has lost image track of the terrorist's movements.

Preferably, security poles 170 should also have an independent means to detect a terrorist who is either in the vicinity of the pole, actually touching the pole, or attempting to damage the pole. It should be recalled that security poles 170 house RF transmitters 230 that communicate intrusions detected by individual UV sensors 195 to RF receiver 235 located at command post 130. These same RF transmitters may be used to communicate the intrusions detected by UV sensors 265, and hence the location of the terrorist Furthermore, security poles 170 supply power to all the mounted sources and sensors. Power is derived either from a direct hard wire that radially extends from the post hub to each of the poles, or from a battery at each of the poles that is employed when prime power is lost.

Now referring to the operation of terrorist shield system 100, the operator in command post 130 randomly scans two different sectors beyond detection shield 115, employing imaging systems 145, 150. He individually scans the lines of sight of each pair of these systems by manipulating a joystick that drives each pan and tilt. One pan and tilt may randomly scan over 180 degrees of a western sector while the second may scan over an equivalent area in an eastern sector. The operator simultaneously views four images. The narrow field of view images can recognize the form of a human body under most conditions. A terrorist assessing the feasibility for an attack or preparing for an attack, could thereby be covertly detected and provide a useful early warning alert.

If the terrorist somehow ultimately deduces the location of detection shield 115, and attempts to tunnel under, or crawl thereunder, he will be detected. If he attempts to jump over the line, he will also be detected. The interruption of covert UV beams 180, or more likely, a concurrent interruption of a number of the beams, will be sensed by sensors 195, and then relayed to command post 130 by co-located RF transmitters 230 housed in a sensor control box via RF antenna 240. The intruded sector will be illuminated on a display console at command post 130, an alarm will sound, and the line of sight for a pan and tilt platform housing imaging systems 145, 150 will be automatically slewed, in azimuth, to the center of that sector, and in elevation, to the center line of detection shield 115.

Following initial detection, the terrorist's movements are tracked via imaging systems 145, 150 and interruptions of UV beams 255 within assessment area 125 that are interior to detection shield 115. Following detection, cameras automatically scan ±35 degrees in azimuth about the sector of detector shield 115 where detection occurred. The operator views these images. Once he has detected the terrorist he assumes manual control of the cameras' lines of sight and tracks the terrorist as he moves inward toward the strategic facility. If the operator fails to acquire an image of the terrorist, after the terrorist has been detected crossing detection shield 115, the forward movement of the terrorist will interrupt covert beams 255 that are criss-crossing in his forward path. A beam interrupt will cause a smaller section of the aforementioned illuminated sector on the display to be illuminated in a different color. The area of uncertainty of the terrorist's location is thus being reduced. The operator then takes his cue from this new development and limits his search to a smaller angular sector and to a reduced distance in range.

Upon imaging of the terrorist and his “baggage”, the operator assesses the situation and elects a course of action. The terrorist may be crawling along the ground and dragging a pouch, running, or he may be one of a group that is moving in a vehicle.

In the assessment process, the operator is also prepared for a diversionary tactic. The terrorists may initially intrude along one bearing to the facility, draw attention, and then launch a second and major encroachment along another bearing. The second imaging system 150, with an independently driven line of sight, is available to assess a second and semi-concurrent intrusion. The same procedure is followed as for the first intrusion. In both cases, the intruders are not aware that the operator is cognizant of their movements and possible intentions.

Depending upon circumstances, the operator can take different measures, such countermeasures illustratively depicted as deterrent shield 120 in terrorist shield system 100. Such countermeasures are invoked as the terrorist nears or is at the lethal range of the facility. The countermeasures, include, but are not limited to, the following:

1. Use of the startle beam, followed immediately by seizure by a security team;

2. Dispatching a security team to the anticipated vehicle disable point;

3. Detonating a sector of an explosive line charge; and/or

4. Detonating a second explosive line charge at a closer location to the facility, and in the same sector.

Assuming the operator is tracking the terrorist with one or both of imaging systems 145, 150, he controls the composite line of sight via a joy stick so that he can position the terrorist in the center of the fields of view. He then simply presses a button to energize very high intensity a visible and near infrared light beam. The beam intensity may be modulated at low and variable frequencies that excite visual nerve networks, causing disorientation and nausea, in addition to intensity over load. The terrorist is thereby temporarily blinded affording an opportunity for a security team to seize him.

Preferably, a security team is assigned to command post 125 for dispatch, on demand, throughout a region of concern. The team consists of 2 or 3 armed men equipped with a high-speed vehicle and remote video reception capability. These forces may be local civil police, military police, or a commercial security firm.

If the terrorist is running, the operator may have an opportunity to disorient him. However, the terrorist may not be immediately captured because the security team has yet to arrive. In this instance, the operator orders the terrorist to stop via a loud speaker and awaits the team's arrival. If the terrorist continues he will soon reach a dual line well inside detection shield 115, typically at a radius of 0.1 mile from the facility center.

Referring to FIG. 7, the circumference formed by the nominal 0.1-mile radius is termed “lethal line” or “lethal range” 280. The nominal location of this line is determined by authorities, who are aware of the practices and capabilities of terrorists. The lethal line location is the desired stand off distance from a terrorist's position to a facility that the authorities would prefer to assure that an explosive-laden individual causes minimal damage were he to detonate a typical explosive charge at that distance.

Two concentric rings 285, 290, appropriately separated, of directed explosive line charge are buried in the ground on either side of lethal line 280. These line charges are preferably broken into twelve separate 30-degree sections. Each charge segment is shaped for a kill radius of about 50 feet over a hemispherical pattern. Each section is separately connected to individual hard-wire lines that provide twelve individual detonate commands, as exercised by the operator at command post 130. These lines are buried and share the same trench, over a shorter distance, used by the hard-wire lines that run radially from the post hub to supply power to security poles 170.

When the terrorist reaches the first of these two explosive lines (285), the operator may detonate the line, exploding both the explosive line and the explosive the terrorist is carrying.

A terrorist racing a vehicle past detection shield 115 toward facility 110 requires a shorter reaction period for the command post operator. To counter this threat, a continuous ring of tire-piercing metal spikes may be permanently placed before the first ring of explosive charges at line 295. These spikes point outward from the facility. They are designed and installed such that they are difficult to visually detect. Upon striking the spikes, the terrorists may dismount and continue on foot. The operator is covertly monitoring these circumstances and can elect to detonate either the first or, subsequently, the second ring of explosives (290), interior to the spiked ring, as circumstances dictate. These explosive line charges may also be reserved by the operator for employment against a crawling or running terrorist if the security team does not arrive in time to intercept his movement to the facility.

If the terrorist is crawling, the operator, upon detection, may call for a security team 300, to intercept the intruder at line 305. As the security team races to the site they view the same images seen by the operator. The team and the operator then discuss how the interception is to take place. The terrorist continues to be unaware that his progress is being monitored. At an appointed time, and/or terrorist location, the operator can excite a startle beam from projector 165, a visible beam that is aimed directly at the terrorist. The terrorist is startled and temporarily blinded, losing all sense of orientation. If he is equipped with night vision goggles, the goggles will bloom and cloud his imagery. The security team moves in and seizes him.

Again, an operator might function from either a command post that is co-located with the facility being protected or from a command post that is remote from the facility. In either case, his detection and deterrent capabilities operate independently. For example, a terrorist may strike down a sensor pole with the intention of rendering the remainder of the system inoperative. In practice, he has alerted the operator to his location and the operator in turn, can track his movements from the pole he struck using equipment and operational procedures that are not dependent on the continuing operation of the pole, as discussed herein above.

Time is the key determinant that dictates what deterrent might be employed. A remotely located security team could consume from 2-5 minutes from the time of dispatch to the time at which they are on site at a specific location. If a terrorist is crawling, with explosives, he may take 5-15 minutes to move from detection shield 115 to lethal line 280, a nominal distance of 0.15 miles. Ample time is thus afforded to disorient the terrorist and seize him. If the terrorist is running, he may take 2 minutes to cover the same distance. The probability of a timely interception is therefore marginal. Such being the case, it is likely that the operator will resort to detonating the explosives. If a group of terrorists are vehicle borne, they could cover the distance in about 0.15 minutes. At this point, their vehicle is disabled by the tire spikes. Two alternatives are presented. If the terrorist(s) is bodily strapped with his own portable explosives, he may simply dismount from the vehicle and run to the target. The operator would be viewing this circumstance, and blast the terrorists and their explosives as they cross one of the explosive line charges. If the explosive package is large and secured in the SUV, the terrorist may become confounded when their vehicle is disabled. The operator could use the startle beam from projector 165 to further confuse them. If the terrorist attempt to remove some of the explosives and carry the explosives and the detonators on his person, the time expended in performing such could be long enough to allow for interception by the security team.

A terrorist, finding a weak link in the security shield that he might exploit to gain entry, will most likely probe the equipment and procedures employed to permit access to the facility by authorized personnel. The present terrorist shield system, however, operates autonomously, independent of any operating safeguards currently in place at a facility to allow for authorized access while deterring trespass by others. Moreover, the present inventive system may complement existing controls by employing its imaging sensors to monitor suspicious activity at an access control gate and/or continue to monitor suspicious individuals or vehicles if they pass through the control gate. In addition, all vehicles that pass the control gate must also pass through a tire-piercing ring in order to reach the shielded facility. Therefore, a means is provided to allow for verbal communication between a control gate guard, and the command post operator. If the operator is convinced that the approval for facility access by the guard is valid, he instructs the guard to inform the vehicle operator to travel toward the facility along one of six randomly spaced 30-degree sectors. The tire piercers installed across each of these selected six sectors can be remotely activated, via individual hard wires from command post 130. A row of metal spikes, pointed upward at a 45° angle in the direction of the approaching vehicle, can be rotated such that the spikes are lying horizontal, flush with the terrain. The operator controls the activation of these devices. He can therefore allow a vehicle to pass through at one of these points or he can withhold “dearming” of these spikes at the previously designated location if he becomes leery of the vehicle operator's intentions following passage through the control gate. In either event, a terrorist scrutinizing these activities from afar, and not aware of the communications and actions involved in allowing an authorized vehicle to pass beyond the tire-piercing ring, may be lead to believe that such a deterrent does not exist. He might then plan his intrusion simply upon crashing the control gate. If he does, the operator will be prepared to thwart him.

A practical balance is thus struck between the characteristics of the inventive security shield employed, the terrorist encounter ranges, installation and manning costs, and the alternatives available to an operator in preventing a terrorist from moving to within lethal range of a facility.

The above description of the invention assumes that the facility being protected and the site of elevated sensor platform 140 were at the center of a circumferential perimeter about which detection and deterrence rings were placed. These same detection and deterrence principles are, however, also applicable to an extended, linear perimeter. In this latter instance, elevated platform 140 is set back and located to cover, upon cue, a linear perimeter that is being monitored by similar UV sensors. The similar multiple detection and deterrent schemes can be employed, and the same cost and simplicity of operation benefits accrue due to the relatively small number of detection sensors and accompanying support structure required, in comparison to the 4 to 16 times more hardware complement required when shorter range detection sensors are employed.

1. A system for protecting a strategic facility from an intruder by providing perimeter intrusion detection and deterrence, said system comprising:
a first set of sources and sensors arranged along an outer perimeter of said strategic facility, and operating in the solar blind region of the ultraviolet spectrum so as to produce a plurality of exterior covert ultraviolet beams around the outer perimeter of said strategic facility, wherein said sensors of said first set upon detecting the interruption of at least one of said exterior covert ultraviolet beams indicates an intrusion to said strategic facility, and thereby establishes a detection shield around the outer perimeter of said strategic facility;
a second set of sources and sensors arranged along said outer perimeter of said strategic facility, and operating in the solar blind region of the ultraviolet spectrum so as to produce criss-crossing interior covert ultraviolet beams within an interior assessment region of the outer perimeter of said strategic facility, wherein said sensors of said second set upon detecting the interruption of at least one of said second interior covert ultraviolet beams indicates the approximate location of an intruder within said interior assessment region; and
means for imaging the intruder and his movement, in part, assisted by the approximate location of the intruder indicated by said second set of sources and sensors.

2. The system of claim 1 wherein the outer perimeter is circular.

3. The system of claim 2 wherein the interior assessment region is substantially annular.

4. The system of claim 1 wherein the outer perimeter is linear.

5. The system of claim 1 wherein the solar blind region is between 0.205-0.275 μm.

6. The system of claim 1 further comprising means for employing countermeasures in thwarting the intruder so as to establish a deterrent shield, one or more of said countermeasures selected on the basis of the location of the intruder within the interior assessment region, and its proximity to the lethal range of the strategic facility.

7. The system of claim 1 wherein the means for imaging includes two separate imaging systems, each including a visible color camera, and an infrared camera.

8. The system of claim 1 further comprising security poles arranged along the outer perimeter of said strategic facility, said first and second sets of sources and sensors mounted near or on said security poles.

9. The system of claim 8 wherein the first set of sources and sensors are arranged on the security poles so as to produce a vertically stacked series of exterior covert ultraviolet beams.

9. The system of claim 8 wherein the second set of sources and sensors are arranged on said security poles so as to produce a vertically stacked series of interior covert ultraviolet beams criss-crossing within the interior assessment region.

10. The system of claim 8 wherein said security poles are equidistantly spaced apart.

11. The system of claim 1 further comprising as part of the detection shield a radio frequency (RF) sensor cable buried below the ground and around the outer perimeter of the strategic facility.

12. The system of claim 1 further comprising as part of said detection shield seismic or acoustic sensors arranged along the outer perimeter of said strategic facility.

13. The system of claim 1 wherein said first and second sets of sources each includes an ultraviolet source, beam forming optics and modulator.

14. The system of claim 1 wherein said first and second sets of sensors each includes an ultraviolet detector responsive to solar blind radiation, a lens and an optical filter for blocking out radiation above 0.275 μm.

15. The system of claim 1 further comprising infrared transmitters for producing infrared beams around the outer perimeter of said strategic facility.

16. The system of claim 1 further comprising means for remotely controlling said means for imaging.
